(19) United States
(12) Patent Application Publication
(10) Pub. No.: US 2011/0205473 A1
(43) Pub. Date: Aug. 25, 2011

(54) LIQUID CRYSTAL DISPLAY PANEL

(76) Inventor: Tomoshige Oda, Osaka (JP)

(21) Appl. No.: 13/126,241

(22) PCT Filed: Aug. 5, 2009
(86) PCT No.: PCT/JP2009/003742

§ 371 Date: Apr. 27, 2011

(30) Foreign Application Priority Data
Jan. 9, 2009 (JP) 2009-003864

(51) Int. Cl. G02F 1/1335

(52) U.S. Cl. 349/104

(57) ABSTRACT

An active matrix substrate (20a) includes switching elements each provided for a pixel, and an interlayer insulating film (15) provided so as to cover the switching elements. A color filter substrate (30) includes a black matrix (21) provided in a frame-like shape in a frame region and provided in a grid pattern in a display region (D), a color filter layer (22) provided so as to cover the black matrix (21) in the display region (D), and columnar photo spacers (23a, 23b) provided so as to be stacked on the black matrix (21) and configured to maintain a thickness of a liquid crystal layer (40). The active matrix substrate (20a) has an under layer (U) formed in the same layer as a part of the switching element and made of the same material as that of the part of the switching element, and the under layer is stacked on the photo spacers (23b) arranged at a liquid crystal injection port (M). Protrusions (T) corresponding to the under layer (U) are provided on a surface of the interlayer insulating film (15).

### TECHNICAL FIELD

The present invention relates to a liquid crystal display panel, and particularly relates to a liquid crystal display panel manufactured by using a vacuum injection method.

### BACKGROUND ART

A liquid crystal display panel includes, e.g., a pair of substrates arranged so as to face each other, and a liquid crystal layer sealed between the pair of substrates. In order to manufacture such a liquid crystal display panel by using the vacuum injection method, e.g., sealing material is printed in a frame-like shape with a liquid crystal injection port on a surface of one of the substrates, and the one of the substrates and the other substrate are bonded together by the sealing material to provide a bonded body. Then, liquid crystal material is injected into the bonded body by using a pressure difference between an inside and an outside of the bonded body and a capillary action, and the liquid crystal injection port is sealed with UV curable resin.

For example, Patent Document 1 discloses a liquid crystal apparatus including a pair of first and second substrates arranged so as to face each other through sealing material, and liquid crystal sealed in a space surrounded by the first and second substrates and the sealing material. In the liquid crystal apparatus, a liquid crystal injection port through which the liquid crystal is injected is provided in the sealing material. In addition, raised sections configured to regulate a spacing between the pair of substrates are provided in a liquid crystal injection port region where the liquid crystal injection port is provided, and protrude from at least one of the pair of substrates toward the other substrate in a position where at least a part of the raised sections is stacked on the liquid crystal injection port region as viewed in plan. Further, the liquid crystal injection port is sealed with end sealing material. According to the liquid crystal apparatus, flexure due to contraction at the liquid crystal injection port can be reduced.

### CITATION LIST

### Patent Document

PATENT DOCUMENT 1: Japanese Patent Publication No. 2007-047239

### SUMMARY OF THE INVENTION

### Technical Problem

FIG. 10 is an enlarged plan view illustrating a portion near a liquid crystal injection port M of a conventional liquid crystal display panel 150 manufactured by using the vacuum injection method. In addition, FIG. 11 is a XI-XI cross-sectional view of the liquid crystal display panel 150 of FIG. 10. Further, FIG. 12 is a plan view illustrating the entire liquid crystal display panel 150.

As illustrated in FIGS. 11 and 12, the liquid crystal display panel 150 includes a TFT (thin film transistor) substrate 120 and a CF (color filter) substrate 130 which are arranged so as to face each other, and a liquid crystal layer 140 provided between the TFT substrate 120 and the CF substrate 130.

As illustrated in FIG. 12, in the liquid crystal display panel 150, a display region D where a plurality of pixels are arranged in matrix, and a frame region F surrounding the display region D are defined in a portion where the TFT substrate 120 and the CF substrate 130 are stacked. A terminal region T is defined in a portion of the TFT substrate 120, which is exposed under the CF substrate 130.

As illustrated in FIG. 10, in the frame region F, sealing material 141 is provided in a frame-like shape with the liquid crystal injection port M through which liquid crystal material forming the liquid crystal layer 140 is injected. Note that, as illustrated in FIGS. 10 and 11, the liquid crystal layer 140 is sealed between the TFT substrate 120 and the CF substrate 130 with the sealing material 141 and end sealing material 142 provided at the liquid crystal injection port M.

As illustrated in FIG. 11, the CF substrate 130 includes a glass substrate 110, a black matrix 121 provided in a frame-like shape in the frame region F and provided in a grid pattern in the display region D on the glass substrate 110, a color filter layer 122 containing, e.g., red, green, and blue layers each provided between the grids of the black matrix 121, a common electrode (not shown in the figure) provided so as to cover the color filter layer 122, and columnar photo spacers 123a, 123b provided so as to be stacked on the black matrix 121 on the common electrode.

Top portions of the photo spacers 123a, 123b contact a surface of the TFT substrate 120, and are configured to maintain a thickness of the liquid crystal layer 140, i.e., a cell thickness. However, as illustrated in FIG. 11, a position of the top portion of the photo spacer 123b provided at the liquid crystal injection port M is lower than a position of the top portion of the photo spacer 123a provided in the display region D. In such a state, as illustrated in FIG. 11, the top portions of the photo spacers 123a contact the surface of the TFT substrate 120 in the display region D, thereby maintaining the cell thickness. However, at the liquid crystal injection port M, the top portions of the photo spacers 123b do not contact the surface of the TFT substrate 120, resulting in a reduced cell thickness. Thus, as illustrated in FIG. 12, the cell thickness near the liquid crystal injection port M (portion indicated by “X” in the figure) becomes non-uniform.

The color filter layer 122 arranged in the display region D is typically formed by applying liquid photosensitive resin having a predetermined color. Thus, the color filter layer 122 is leveled and thinly formed on the relatively-thin grid-like black matrix 121 on which the photo spacers 123a are arranged. If the color filter layer is formed at the liquid crystal injection port M on the relatively-thick frame-like black matrix 121 (integrally-formed black matrix 121) on which the photo spacers 123b are arranged, the liquid photosensitive resin is not leveled, thereby thickly forming the color filter layer. This increases the cell thickness at the liquid crystal injection port M, and therefore the color filter layer cannot be arranged on the frame-like black matrix 121 on which the photo spacers 123b are arranged.

For the reasons above, the position of the top portion of the photo spacer 123b provided at the liquid crystal injection port M is lower than the position of the top portion of the photo spacer 123a provided in the display region D. As a result, it is likely that the cell thickness near the liquid crystal injection port M becomes non-uniform. In particular, in a liquid crystal display panel in which the liquid crystal injection port M is designed so as to have a large width in order to shorten an injection time of liquid crystal material, it is more likely that the cell thickness near the liquid crystal injection port M becomes non-uniform.

The present invention has been made in view of the foregoing, and it is an objective of the present invention to reduce a non-uniform cell thickness near a liquid crystal injection port.

### Solution to the Problem

In order to accomplish the foregoing objective, protrusions corresponding an under layer formed in the same layer as a part of a switching element and made of the same material as that of the part of the switching element are provided on a surface of an interlayer insulating film in the present invention.

Specifically, a liquid crystal display panel of the present invention includes an active matrix substrate and a color filter substrate arranged so as to face each other; a liquid crystal layer provided between the active matrix substrate and the color filter substrate; and sealing material provided to seal the liquid crystal layer between the active matrix substrate and the color filter substrate, and formed so as to have a liquid crystal injection port through which liquid crystal material forming the liquid crystal layer is injected. A display region where a plurality of pixels are arranged to display an image, and a frame region where the sealing material is applied around the display region are defined. The active matrix substrate includes switching elements each provided for each of the pixels, and an interlayer insulating film provided so as to cover the switching elements. The color filter substrate includes a black matrix provided in a frame-like shape in the frame region and provided in a grid pattern in the display region, a color filter layer provided so as to cover the black matrix in the display region, and columnar photo spacers provided so as to be stacked on the black matrix and contacting a surface of the active matrix substrate to maintain a thickness of the liquid crystal layer. The active matrix substrate further includes an under layer formed in the same layer as a part of the switching element and made of the same material as that of the part of the switching element, the under layer being stacked on the photo spacers arranged at the liquid crystal injection port. Protrusions corresponding to the under layer are provided on a surface of the interlayer insulating film.

According to the foregoing configuration, in a region of the active matrix substrate, where the liquid crystal injection port of the sealing material is arranged, the protrusions which protrude corresponding to the under layer formed in the same layer as a part of the switching element and made of the same material as that of the part of the switching element are provided on the surface of the interlayer insulating film covering the switching elements. Thus, even if, in the color filter substrate, a position of a top portion of the photo spacer provided so as to be stacked on the black matrix in a region of the frame region, where the liquid crystal injection port of the sealing material is arranged is lower than a position of a top portion of the photo spacer provided so as to be stacked on the black matrix of the display region by a thickness of the color filter layer, the top portion of the photo spacer can be in contact with the surface of the active matrix substrate or be closer to the surface of the active matrix substrate in the region where the liquid crystal injection port of the sealing material is arranged. This maintains the thickness of the liquid crystal layer not only in the display region but also in the region where the liquid crystal injection port of the sealing material is arranged. Thus, a non-uniform cell thickness in a portion near the liquid crystal injection port can be reduced.

Each of the switching elements may be a thin film transistor, and the under layer may include at least one of a first under layer formed in the same layer as a gate electrode of the thin film transistor and made of the same material as that of the gate electrode of the thin film transistor, a second under layer formed in the same layer as a semiconductor layer of the thin film transistor and made of the same material as that of the semiconductor layer of the thin film transistor, or a third under layer formed in the same layer as source and drain electrodes of the thin film transistor and made of the same material as that of the source and drain electrodes of the thin film transistor.

According to the foregoing configuration, the under layer includes at least one of the first under layer formed in the same layer as the gate electrode of the thin film transistor and made of the same material as that of the gate electrode of the thin film transistor, the second under layer formed in the same layer as the semiconductor layer of the thin film transistor and made of the same material as that of the semiconductor layer of the thin film transistor, or the third under layer formed in the same layer as the source and drain electrodes of the thin film transistor and made of the same material as that of the source and drain electrodes of the thin film transistor. Thus, the under layer can be specifically formed in the active matrix substrate without additional manufacturing steps.

The active matrix substrate may include a pixel electrode provided for each of the pixels on the interlayer insulating film. An upper layer is provided on the protrusion, and is formed in the same layer as the pixel electrode and made of the same material as that of the pixel electrode.

According to the foregoing configuration, the upper layer formed in the same layer as the pixel electrode and made of the same material as that of the pixel electrode is provided on the protrusion. Thus, in the active matrix substrate, the position of the top portion of the protrusion protruding corresponding to the under layer can be set to a higher level.

### Advantages of the Invention

According to the present invention, the protrusions corresponding to the under layer formed in the same layer as a part of the switching element and made of the same material as that of the part of the switching element are provided on the surface of the interlayer insulating film. Thus, the non-uniform cell thickness in the portion near the liquid crystal injection port can be reduced.

### BRIEF DESCRIPTION OF THE DRAWINGS

FIG. 1 is a plan view of a liquid crystal display panel 50a of a first embodiment.

FIG. 2 is an enlarged plan view from a CF substrate 30 side, which illustrates a portion near a liquid crystal injection port M of the liquid crystal display panel 50a.

FIG. 3 is an enlarged plan view from a TFT substrate 20a side, which illustrates the portion near the liquid crystal injection port M of the liquid crystal display panel 50a.

FIG. 4 is an IV-IV cross-sectional view of the liquid crystal display panel 50a of FIGS. 2 and 3.

FIG. 5(a)-5(e) are cross-sectional views illustrating manufacturing steps of the TFT substrate 20a.

FIG. 6 is a cross-sectional view of a liquid crystal display panel 50b of a second embodiment.

FIG. 7 is a cross-sectional view of a liquid crystal display panel 50c of the second embodiment.

FIG. 8 is a cross-sectional view of a liquid crystal display panel 50d of a third embodiment.

FIG. 9 is a cross-sectional view of a liquid crystal display panel 50e of a fourth embodiment.

FIG. 10 is an enlarged plan view illustrating a portion near a liquid crystal injection port M of a conventional liquid crystal display panel 150 manufactured by using a vacuum injection method.

FIG. 11 is a XI-XI cross-sectional view of the entire liquid crystal display panel 150 of FIG. 10.

FIG. 12 is a plan view of the liquid crystal display panel 150.

### DESCRIPTION OF EMBODIMENTS

Embodiments of the present invention will be described below in detail with reference to the drawings. Note that the present invention is not limited to the embodiments below.

### First Embodiment of the Invention

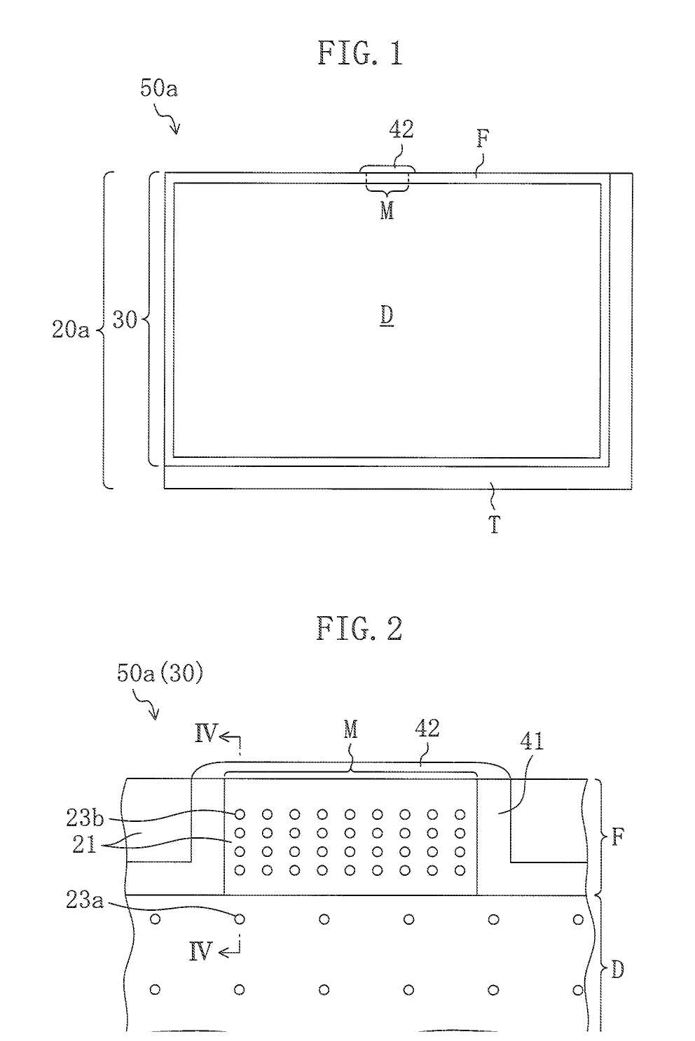

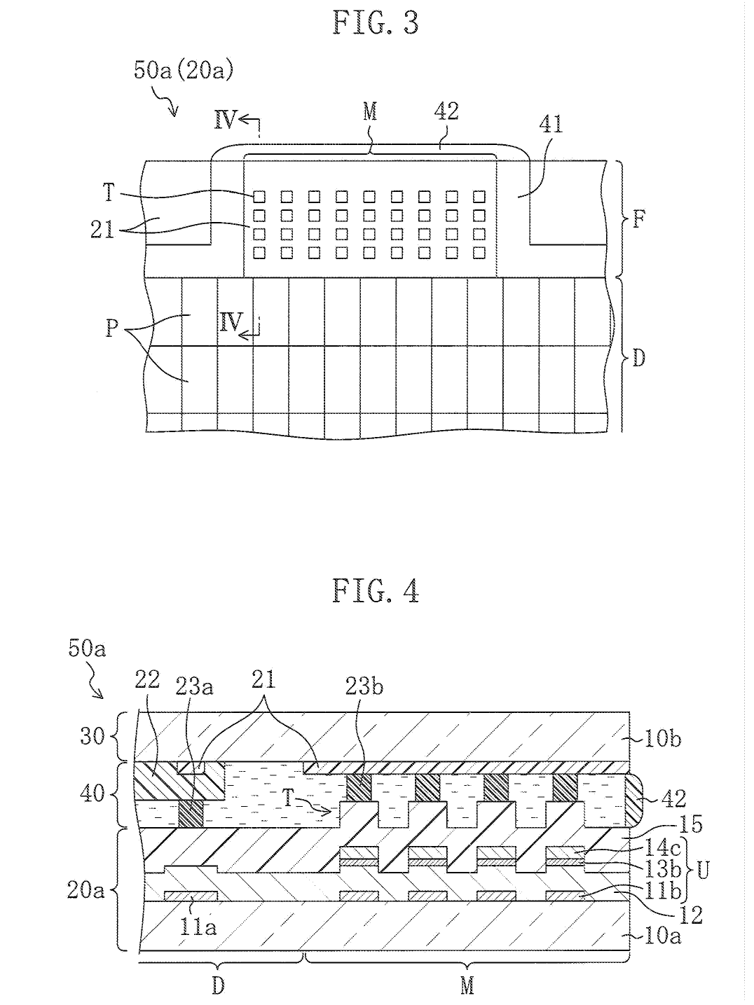

FIGS. 1-5 illustrate a first embodiment of a liquid crystal display panel of the present invention. FIG. 1 is a plan view of a liquid crystal display panel 50a of the present embodiment. FIG. 2 is an enlarged plan view from a CF substrate 30 side, which illustrates a portion near a liquid crystal injection port M of the liquid crystal display panel 50a, and FIG. 3 is an enlarged plan view from a TFT substrate 20a side, which illustrates the portion near the liquid crystal injection port M of the liquid crystal display panel 50a. FIG. 4 is an IV-IV cross-sectional view of the liquid crystal display panel 50a of FIGS. 2 and 3. Note that TFTs and pixel electrodes formed in the TFT substrate 20a are omitted in FIG. 4.

As illustrated in FIGS. 1 and 4, the liquid crystal display panel 50a includes the TFT substrate 20a provided as an active matrix substrate, the CF substrate 30 arranged so as to face the TFT substrate 20a, a liquid crystal layer 40 provided between the TFT substrate 20a and the CF substrate 30, sealing material 41 provided between the TFT substrate 20a and the CF substrate 30, which is for bonding the TFT substrate 20a and the CF substrate 30 together and sealing the liquid crystal layer 40 between the TFT substrate 20a and the CF substrate 30.

As illustrated in FIG. 1, in the liquid crystal display panel 50a, a display region D where a plurality of pixels P (see FIG. 3) are arranged in matrix in order to display an image, and a frame region F surrounding the display region D are defined in a portion where the TFT substrate 20a and the CF substrate 30 are stacked. A terminal region T where various connection terminals are formed is defined in a portion of the TFT substrate 20a, which is exposed under the CF substrate 30.

As illustrated in FIGS. 2 and 3, in the frame region F, the sealing material 41 having the liquid crystal injection port M through which liquid crystal material forming the liquid crystal layer 40 is injected at one side is provided in a substantially frame-like shape. As illustrated in FIGS. 2-4, the liquid crystal layer 40 is sealed between the TFT substrate 20a and the CF substrate 30 with the sealing material 41 and end sealing material 42 provided at the liquid crystal injection port M.

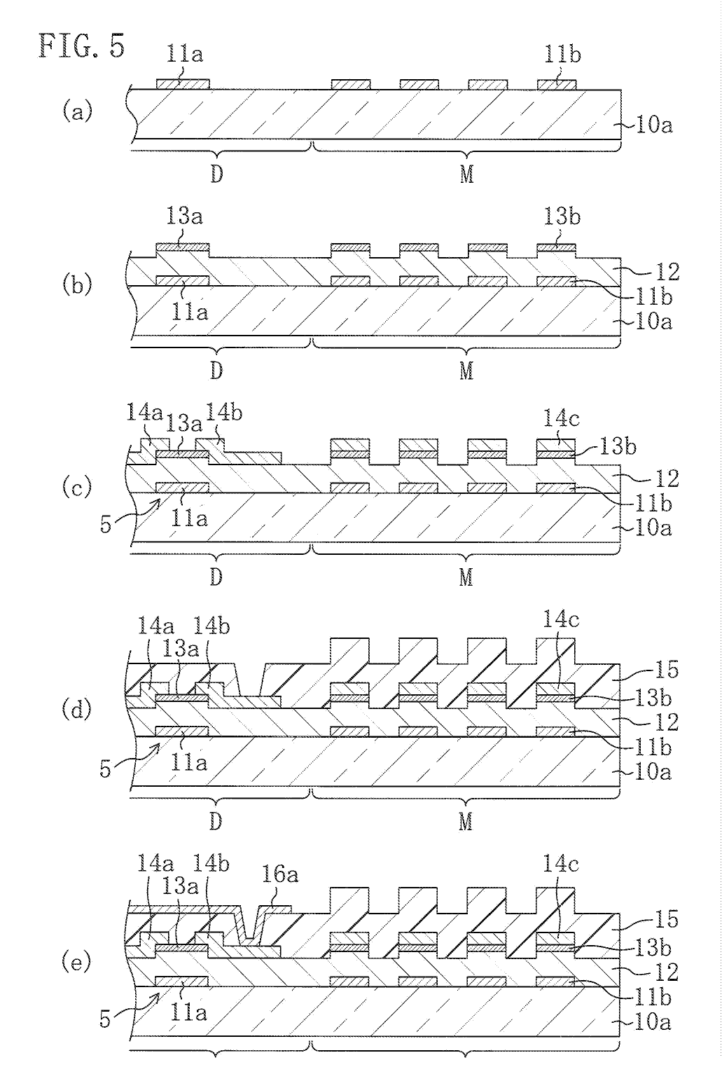

As illustrated in FIGS. 3 and 4, the TFT substrate 20a includes an insulating substrate 10a such as a glass substrate, a plurality of gate lines (not shown in the figure) provided so as to extend parallel to each other on the insulating substrate 10a, a plurality of source lines (not shown in the figure) provided so as to extend parallel to each other in a direction perpendicular to the gate lines, a plurality of TFTs 5 (see FIG. 5) each provided at an intersection of the gate line and the source line, an interlayer insulating film 15 provided so as to cover the TFTs 5, a plurality of pixel electrodes 16a provided in matrix on the interlayer insulating film 15 and each connected to the TFT 5, and an alignment film (not shown in the figure) provided so as to cover the pixel electrodes 16a.

As illustrated in FIG. 5 which will be described later, the TFT 5 includes a gate electrode 11a which is a portion laterally protruding from the gate line, a gate insulating film 12 provided so as to cover the gate electrode 11a, a semiconductor layer 13a provided in an island-like shape in a position corresponding to the gate electrode 11a on the gate insulating film 12, and a source electrode 14a and a drain electrode 14b provided so as to face each other on the semiconductor layer 13a. The semiconductor layer 13a includes an intrinsic amorphous silicon layer (not shown in the figure) as a lower layer, in which a channel region (not shown in the figure) is defined on an upper surface, and an n⁺ amorphous silicon layer (not shown in the figure) provided above the intrinsic amorphous silicon layer. The source electrode 14a is a portion laterally protruding from the source line. The drain electrode 14b is connected to the pixel electrode 16a through a contact hole (not shown in the figure) formed in the interlayer insulating film 15.

As illustrated in FIG. 4, in the TFT substrate 20a, an under layer U is provided so as to be stacked on photo spacers 23b (arranged at the liquid crystal injection port M) which will be described later, and protrusions T protruding corresponding to the under layer U are provided on a surface of the interlayer insulating film 15.

As illustrated in FIG. 4, the under layer U includes three layers which are a first under layer ii b formed in the same layer as the gate electrode 11a of the TFT 5 and made of the same material as that of the gate electrode 11a of the TFT 5, a second under layer 13b formed in the same layer as the semiconductor layer 13a of the TFT 5 and made of the same material as that of the semiconductor layer 13a of the TFT 5, and a third under layer 14c formed in the same layer as the source electrode 14a and the drain electrode 14b of the TFT 5 and made of the same layer as that of the source electrode 14a and the drain electrode 14b of the TFT 5.

As illustrated in FIGS. 2 and 4, the CF substrate 30 includes an insulating substrate 10b such as a glass substrate, a black matrix 21 provided in a frame-like shape in the frame region F and provided in a grid pattern in the display region D on the insulating substrate 10b, a color filter layer 22 containing, e.g., red, green, and blue layers each provided between the grids of the black matrix 21, a common electrode (not shown in the figure) provided so as to cover the color filter layer 22, columnar photo spacers 23a, 23b provided so as to be stacked on the black matrix 21 on the common electrode, and an alignment film (not shown in the figure) provided so as to cover the common electrode.

As illustrated in FIG. 4, the color filter layer 22 in which each of the colored layers is arranged between the grids of the black matrix 21 is provided so as to cover the black matrix 21 in order not to produce clearances between the colored layers. In addition, as illustrated in FIG. 4, the photo spacers 23a are provided so as to be stacked on the black matrix 21 of the display region D through the color filter layer 22, and the photo spacers 23b are provided so as to be stacked on the black matrix 21 arranged at the liquid crystal injection port M of the frame region F.

The liquid crystal layer 40 is made of e.g., nematic liquid crystal material having electro-optical properties.

In the liquid crystal display panel 50a having the foregoing configuration, predetermined voltage is applied to the liquid crystal layer 40 arranged between each of the pixel electrodes 16a on the TFT substrate 20a and the common electrode on the CF substrate 30, for each pixel P, thereby changing an alignment state of the liquid crystal layer 40. Thus, a light transmittance through a panel is adjusted for each pixel P, thereby displaying the image.

Next, a method for manufacturing the liquid crystal display panel 50a of the present embodiment will be described with reference to FIG. 5. The manufacturing method of the present embodiment includes manufacturing of a TFT substrate, manufacturing of a CF substrate, and injection of liquid crystal. Note that FIGS. 5(a)-5(e) are cross-sectional views illustrating manufacturing steps of the TFT substrate 20a.

<Manufacturing of the TFT Substrate>

First, e.g., a titanium film, an aluminum film, and a titanium film are successively formed on an entire insulating substrate 10a such as a glass substrate by sputtering. Then, such films are patterned by photolithography, and therefore gate lines (not shown in the figure), gate electrodes 11a, and a first under layer 11b are formed in a thickness of about 0.2 μm as illustrated in FIG. 5(a).

Subsequently, e.g., a silicon nitride film is formed on the entire substrate on which the gate lines, the gate electrodes 11a, the first under layer 11b are formed, by plasma CVD (chemical vapor deposition). A gate insulating film 12 is formed in a thickness of about 0.4 μm.

Further, an intrinsic amorphous silicon film and a phosphorus-doped n+amorphous silicon film are successively formed on the entire substrate on which the gate insulating film 12 is formed, by the plasma CVD. Then, such films are patterned in an island-like shape on the gate electrodes 11a and the first under layer 11b by the photolithography. As a result, as illustrated in FIG. 5(b), a semiconductor layer 13a and a second under layer 13b are formed, in which an intrinsic amorphous silicon layer having a thickness of about 0.1 μm and an n+amorphous silicon layer having a thickness of about 0.05 μm are stacked.

Then, e.g., an aluminum film and a titanium film are successively formed on the entire substrate on which the semiconductor layer 13a and the second under layer 13b are formed, by the sputtering. Subsequently, such films are patterned by the photolithography, and source lines (not shown in the figure), source electrodes 14a, drain electrodes 14b, and a third under layer 14c are formed in a thickness of about 0.35 μm as illustrated in FIG. 5(c).

Subsequently, the n+amorphous silicon layer of the semiconductor layer 13a is etched by using the source electrodes 14a and the drain electrodes 14b as a mask, and channel portions are patterned to form TFTs 5.

Then, e.g., an inorganic insulating film such as a silicon nitride film is formed in a thickness of about 0.3 μm on the entire substrate on which the TFTs 5 are formed, by the plasma CVD, followed by applying, e.g., acrylic photosensitive resin so as to have a thickness of about 2.5 μm by spin coating. Subsequently, the applied photosensitive resin is exposed to light and developed through a photo mask, thereby forming an organic insulating film in which contact holes are patterned on the drain electrodes 14b. Then, the inorganic insulating film exposed under the organic insulating film is etched to form the contact holes, thereby forming an interlayer insulating film 15 as illustrated in FIG. 5(d).

An ITO (indium tin oxide) film is formed on the entire substrate on which the interlayer insulating film 15 is formed, by the sputtering. Subsequently, such a film is patterned by the photolithography, and pixel electrodes 16a are formed in a thickness of about 0.1 μm as illustrated in FIG. 5(e).

Finally, polyimide resin is applied to the entire substrate on which the pixel electrodes 16a are formed, by printing. Subsequently, a rubbing process is performed, thereby forming an alignment film in a thickness of about 0.1 μm.

In the manner described above, a TFT substrate 20a can be manufactured.

<Manufacturing of the CF Substrate>

First, e.g., acrylic photosensitive resin in which particulates such as carbon are dispersed is applied to an entire insulating substrate 10b such as a glass substrate by the spin coating. Then, the applied photosensitive resin is exposed to light through a photo mask, and is developed. As a result, a black matrix 21 is formed in a thickness of about 1.5 μm.

Subsequently, e.g., acrylic photosensitive resin colored red, green, or blue is applied to the substrate on which the black matrix 21 is formed. For patterning, the applied photosensitive resin is exposed to light through the photo mask and is developed. Then, a colored layer having a selected color (e.g., a red-colored layer) is formed in a thickness of about 2.0 μm. Further, the similar process is repeated for other two colors. Colored layers having the other two colors (e.g., a green-colored layer and a blue-colored layer) are formed in a thickness of about 2.0 μm, thereby forming a color filter layer 22.

Then, e.g., an ITO film is formed on the substrate on which the color filter layer 22 is formed, by the sputtering, thereby forming a common electrode in a thickness of about 1.5 μm.

Subsequently, photosensitive resin is applied to the entire substrate on which the common electrode is formed, by the spin coating. The applied photosensitive resin is exposed to light through the photo mask and is developed, thereby forming photo spacers 23a, 23b in a thickness of about 4 μm.

Finally, polyimide resin is applied to the entire substrate on which the photo spacers 23a, 23b are formed, by the printing. Then, the rubbing process is performed, thereby forming an alignment film in a thickness of about 0.1 μm.

In the manner described above, a CF substrate 30 can be manufactured.

<Injection of Liquid Crystal>

First, sealing material 41 made of thermoset resin is applied to a frame region F of the CF substrate 30 manufactured in the manufacturing of the CF substrate, by the printing.

Subsequently, the CF substrate 30 to which the sealing material 41 is applied, and the TFT substrate 20a manufactured in the manufacturing of the TFT substrate are bonded together. Then, such substrates are heated in order to cure the sealing material 41 between the TFT substrate 20a and the CF substrate 30.

Further, liquid crystal material is injected between the TFT substrate 20a and the CF substrate 30 of the bonded body in which the sealing material 41 is cured, through a liquid crystal injection port M by a vacuum injection method. Then, the liquid crystal injection port M is sealed with end sealing material 42 made of UV curable resin, thereby forming a liquid crystal layer 40.

In the manner described above, a liquid crystal display panel 50a of the present embodiment can be manufactured.

As described above, according to the liquid crystal display panel 50a of the present embodiment, in a region of the TFT substrate 20a, where the liquid crystal injection port M of the sealing material 41 is arranged, the protrusions T which protrude corresponding to the under layer U including the first under layer 11b, the second under layer 13b, and the third under layer 14c which are formed in the same layer as the gate electrode 11a, the semiconductor layer 13a, the source electrode 14a, and the drain electrode 14b of the TFT 5 and are made of the same material as those of gate electrode 11a, the semiconductor layer 13a, the source electrode 14a, and the drain electrode 14b of the TFT 5 are provided on the surface of the interlayer insulating film 15 covering the TFTs 5. Thus, even if, in the CF substrate 30, the position of the top portion of the photo spacer 23b provided so as to be stacked on the black matrix 21 in the region of the frame region F, where the liquid crystal injection port M of the sealing material 41 is arranged is lower than the position of the top portion of the photo spacer 23a provided so as to be stacked on the black matrix 21 of the display region D by the thickness of the color filter layer 22, the top portion of the photo spacer 23b can be in contact with the surface of the TFT substrate 20a or be closer to the surface of the TFT substrate 20a in the region where the liquid crystal injection port M of the sealing material 41 is arranged. This maintains the thickness of the liquid crystal layer 40 not only in the display region D but also in the region where the liquid crystal injection port M of the sealing material 41 is arranged. Thus, the non-uniform cell thickness in the portion near the liquid crystal injection port M can be reduced without additional manufacturing steps.

### Second Embodiment of the Invention

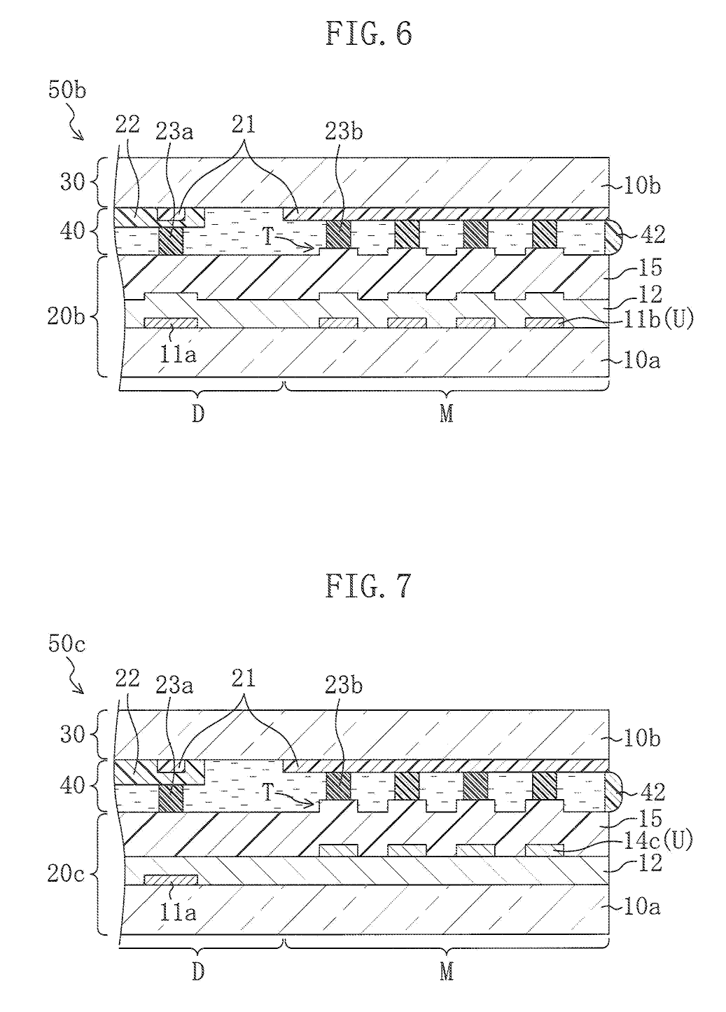

FIGS. 6 and 7 are cross-sectional views of liquid crystal display panels 50b, 50c of the present embodiment. Note that, in FIGS. 6 and 7, TFTs and pixel electrodes formed in TFT substrates 20b, 20c are omitted as in FIG. 4. In embodiments below, the same reference numerals as shown in FIGS. 1-5 are used to represent equivalents elements, and the description thereof will not be repeated.

In the liquid crystal display panel 50a of the first embodiment, the under layer U has the three-layer structure of the first under layer 11b, the second under layer 13b, and the third under layer 14c. However, in the liquid crystal display panels 50b, 50e of the present embodiment, an under layer U has a single-layer structure.

Specifically, as illustrated in FIG. 6, in the liquid crystal display panel 50b, the first under layer 11b of the first embodiment forms the under layer U in the TFT substrate 20b, and other configurations are the substantially same as those of the liquid crystal display panel 50a of the first embodiment.

In addition, as illustrated in FIG. 7, in the liquid crystal display panel 50c, the third under layer 14c of the first embodiment forms the under layer U in the TFT substrate 20c, and other configurations are the substantially same as those of the liquid crystal display panel 50a of the first embodiment.

The liquid crystal display panel 50b having the foregoing configuration can be manufactured by the manufacturing method described in the first embodiment, in which the formation of the second under layer 13b and the third under layer 14c is skipped. In addition, the liquid crystal display panel 50c having the foregoing configuration can be manufactured by the manufacturing method described in the first embodiment, in which the formation of the first under layer 11b and the second under layer 13b is skipped.

According to the liquid crystal display panels 50b, 50c of the present embodiment, protrusions T corresponding to the under layer U formed in the same layer as a part of a TFT 5 and made of the same material as that of the part of the TFT 5 are provided on a surface of an interlayer insulating film 15 as in the first embodiment. Thus, a non-uniform cell thickness in a portion near a liquid crystal injection port M can be reduced without additional manufacturing steps.

In the present embodiment, the example has been described, in which the under layer U includes the single layer which is the first under layer 11b or the third under layer 14c of the first embodiment. However, the under layer U may include a single layer which is the second under layer 13b of the first embodiment.

### Third Embodiment of the Invention

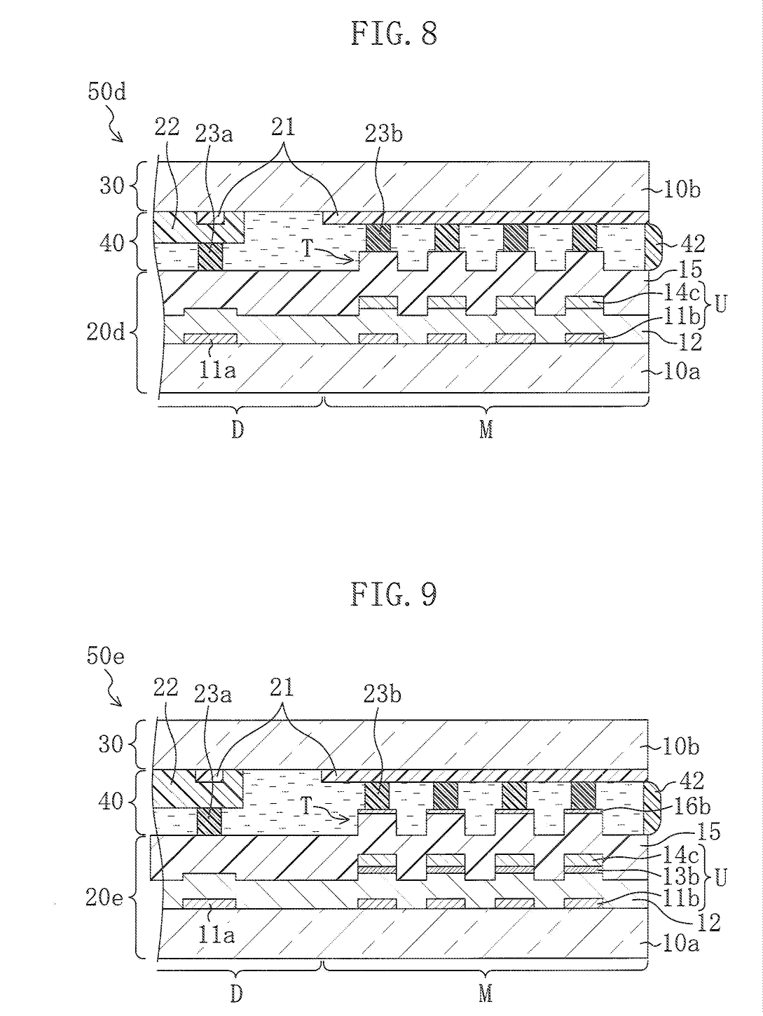

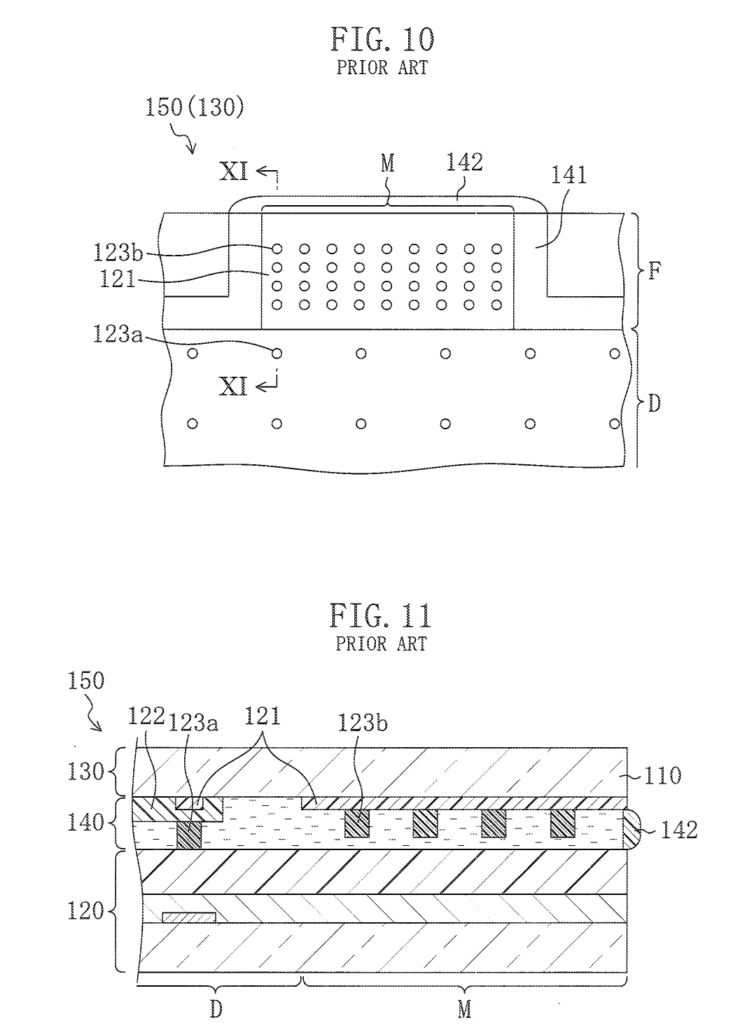

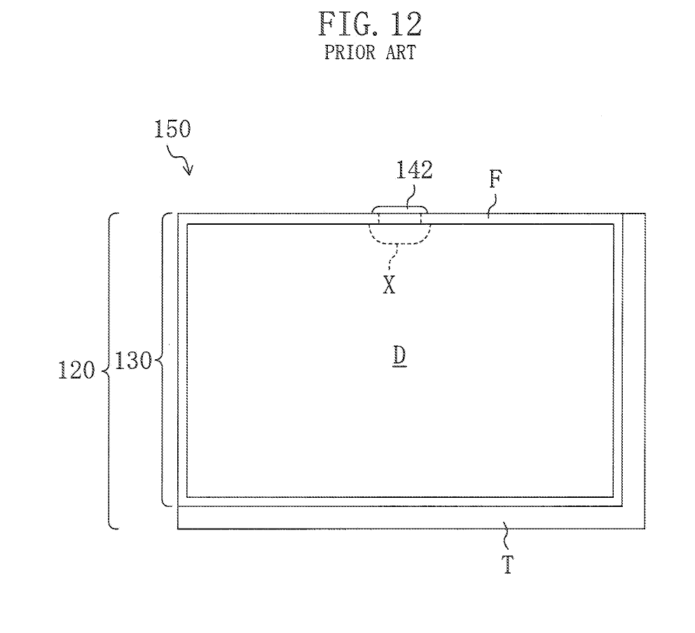

FIG. 8 is a cross-sectional view of a liquid crystal display panel 50d of the present embodiment. Note that in FIG. 8, TFTs and pixel electrodes formed in a TFT substrate 20d are omitted as in FIGS. 4, 6, and 7.

In the liquid crystal display panel 50a of the first embodiment, the under layer U has the three-layer structure of the first under layer 11b, the second under layer 13b, and the third under layer 14c, and, in the liquid crystal display panels 50b, 50c of the second embodiment, the under layer U has the single-layer structure. However, in the liquid crystal display panel 50d of the present embodiment, an under layer U has a double-layer structure.

Specifically, as illustrated in FIG. 8, in the liquid crystal display panel 50d, the first under layer 11b and the third under layer 14c of the first embodiment form the under layer U in the TFT substrate 20d, and other configurations are the substantially same as those of the liquid crystal display panel 50a of the first embodiment.

The liquid crystal display panel 50d can be manufactured by the manufacturing method described in the first embodiment, in which the formation of the second under layer 13b is skipped.

According to the liquid crystal display panel 50d of the present embodiment, protrusions T corresponding to the under layer U formed in the same layer as a part of a TFT 5 and made of the same material as that of the part of the TFT 5 are provided on a surface of an interlayer insulating film 15 as in the first and second embodiments. Thus, a non-uniform cell thickness in a portion near a liquid crystal injection port M can be reduced.

In the present embodiment, the example has been described, in which the under layer U includes the two layers which are the first under layer 11b and the third under layer 14c of the first embodiment. However, the under layer U may include two layers which are the first under layer 11b and the second under layer 13b of the first embodiment, or the second under layer 13b and the third under layer 14c of the first embodiment.

### Fourth Embodiment of the Invention

FIG. 9 is a cross-sectional view of a liquid crystal display panel 50e of the present embodiment. Note that, in FIG. 9, TFTs and pixel electrodes formed in a TFT substrate 20e are omitted as in FIGS. 4, 6, 7, and 8.

In the liquid crystal display panels 50a-50d of the first to third embodiments, the protrusions T are formed corresponding to the under layer U. However, in the liquid crystal display panel 50e of the present embodiment, each of protrusions T includes an upper layer 16b.

Specifically, as illustrated in FIG. 9, in the liquid crystal display panel 50e, the first under layer 11b, the second under layer 13b, and the third under layer 14c of the first embodiment form an under layer U in the TFT substrate 20e, and the upper layer 16b formed in the same layer as a pixel electrode 16a and made of the same material as that of the pixel electrode 16a is provided on a top portion of the protrusion T. Other configurations are the substantially same as those of the liquid crystal display panel 50a of the first embodiment.

The liquid crystal display panel 50e having the foregoing configuration can be manufactured by the manufacturing method described in the first embodiment, in which a pattern shape when etching an ITO film forming the pixel electrode 16a is changed as necessary.

According to the liquid crystal display panel 50e of the present embodiment, the protrusions T corresponding to the under layer U formed in the same layer as a part of a TFT 5 and made of the same material as that of the part of the TFT 5 are provided on a surface of an interlayer insulating film 15 as in the first to third embodiments. Thus, a non-uniform cell thickness in a portion near a liquid crystal injection port M can be reduced without additional manufacturing steps. In addition, the upper layer 16b formed in the same layer as the pixel electrode 16a and made of the same material as that of the pixel electrode 16a is provided on the protrusion T. Thus, in the TFT substrate 20e, a position of the top portion of the protrusion T protruding corresponding to the under layer U can be set to a higher level.

In the present embodiment, the example has been described, in which the upper layer 16b is stacked on the under layer U of the first embodiment. However, a configuration may be applied, in which the upper layer 16b is stacked on each of the under layers U of the second and third embodiments.

In the foregoing embodiments, the TFT is described as an example of a switching element. However, the present invention may be applied to other switching elements such as MIM (metal insulator metal).

### INDUSTRIAL APPLICABILITY

As described above, the present invention reduces the non-uniform cell thickness in the portion near the liquid crystal injection port, and therefore is useful for the liquid crystal display panel manufactured by using the vacuum injection method.

### DESCRIPTION OF REFERENCE CHARACTERS

D Display Region
F Frame Region
M Liquid Crystal Injection Port
P Pixel
T Protrusion
U Under Layer
5 TFT (Switching Element)
11a Gate Electrode
11b First Under Layer
13a Semiconductor Layer
13b Second Under Layer
14a Source Electrode
14b Drain Electrode
14c Third Under Layer
15 Interlayer Insulating Film
16a Pixel Electrode
16b Upper Layer
20a-20e TFT Substrate (Active Matrix Substrate)
21 Black Matrix
22 Color Filter Layer
23a, 23b Photo Spacer
30 CF Substrate
40 Liquid Crystal Layer
41 Sealing Material
50a-50e Liquid Crystal Display Device

1. A liquid crystal display panel, comprising:
an active matrix substrate and a color filter substrate arranged so as to face each other;
a liquid crystal layer provided between the active matrix substrate and the color filter substrate; and
sealing material provided to seal the liquid crystal layer between the active matrix substrate and the color filter substrate, and formed so as to have a liquid crystal injection port through which liquid crystal material forming the liquid crystal layer is injected,
wherein a display region where a plurality of pixels are arranged to display an image, and a frame region where the sealing material is applied around the display region are defined,
the active matrix substrate includes switching elements each provided for each of the pixels, and an interlayer insulating film provided so as to cover the switching elements,
the color filter substrate includes a black matrix provided in a frame-like shape in the frame region and provided in a grid pattern in the display region, a color filter layer provided so as to cover the black matrix in the display region, and columnar photo spacers provided so as to be stacked on the black matrix and contacting a surface of the active matrix substrate to maintain a thickness of the liquid crystal layer,
the active matrix substrate further includes an under layer formed in the same layer as a part of the switching element and made of the same material as that of the part of the switching element, the under layer being stacked on the photo spacers arranged at the liquid crystal injection port, and
protrusions corresponding to the under layer are provided on a surface of the interlayer insulating film.

2. The liquid crystal display panel of claim 1, wherein
each of the switching elements is a thin film transistor, and
the under layer includes at least one of a first under layer formed in the same layer as a gate electrode of the thin film transistor and made of the same material as that of the gate electrode of the thin film transistor, a second under layer formed in the same layer as a semiconductor layer of the thin film transistor and made of the same material as that of the semiconductor layer of the thin film transistor, or a third under layer formed in the same layer as source and drain electrodes of the thin film transistor and made of the same material as that of the source and drain electrodes of the thin film transistor.

3. The liquid crystal display panel of claim 1 wherein
the active matrix substrate includes a pixel electrode provided for each of the pixels on the interlayer insulating film, and
an upper layer is provided on the protrusion, the upper layer being formed in the same layer as the pixel electrode and made of the same material as that of the pixel electrode.
